(19) United States
(12) Patent Application Publication
(10) Pub. No.: US 2005/0168405 A1
(43) Pub. Date: Aug. 4, 2005

(54) Method of driving plasma display panel and plasma display device

(76) Inventors: Jun-Young Lee, Suwon-si (KR); Joon-Koo Kim, Suwon-si (KR)

Correspondence Address: Robert E. Bushnell, Suite 300, 1522 K Street, N.W., Washington, DC, 20005-1202, US

(21) Appl. No.: 11/041,389

(22) Filed: Jan. 25, 2005

(30) Foreign Application Priority Data
Jan. 29, 2004 (KR) 10-2004-0005875

(51) Int. Cl. G09G 3/28

(52) U.S. Cl. 345/60

(57) ABSTRACT

In a plasma display panel, a period of a sustain discharge waveform alternately applied to scan electrodes and sustain electrodes during a sustain period is varied with a display load ratio. That is, the period of the sustain discharge waveform is reduced because light caused by the sustain discharge waveform is stabilized when the display load ratio is lower. Accordingly, an idle period that is increased when the period of the sustain discharge waveform is decreased can be allocated to an address period or a reset period.

### CLAIM OF PRIORITY

This application makes reference to, incorporates the same herein, and claims all benefits accruing under 35 U.S.C. §119 from an application entitled DRIVING METHOD OF PLASMA DISPLAY PANEL AND PLASMA DISPLAY DEVICE filed with the Korean Intellectual Property Office on Jan. 29, 2004 and there duly assigned Serial No. 10-2004-0005875.

### BACKGROUND OF THE INVENTION

1. Field of the Invention

The present invention relates to a plasma display device, and more particularly, to sustain discharge waveforms applied to a plasma display device.

2. Description of the Related Art

A plasma display panel is a flat panel display that displays characters or images using plasma generated by gas discharge. The plasma display device is constructed such that tens to millions pixels are arranged in a matrix form. A plasma display panel is classified into a DC type or an AC type depending on the shape of a driving voltage waveform applied to the panel and the structure of a discharge cell (referred to as “cell” hereinafter) corresponding to each pixel.

In the DC plasma display panel, electrodes are exposed in a discharge space so that a current flows in the discharge space while a voltage is applied to the electrodes. This requires a resistor for restricting the current. In the AC plasma display panel, electrodes are covered with a dielectric layer SO that current is restricted by a natural capacitance component formed by the electrodes and the dielectric layer. Furthermore, in an AC plasma display panel, the electrodes are protected by the dielectric layer from ion collision when discharge occurs. Thus, the AC plasma display panel has a longer life span than the DC plasma display panel.

In the AC type plasma display panel, a single temporal frame is divided into a plurality of sub-fields. Each sub-field includes a reset period, an address period, and a sustain period. The reset period initializes the state of each cell such that the cell is smoothly addressed. The address period distinguishes lit cells (addressed cells) from cells that are not lit and accumulates wall charges on the lit cells. That is, the address period increases the quantity of charges attached to the lit cells. During the sustain period, a predetermined number of discharges are generated for the addressed cells in order to display an image.

Since each sub-field includes the reset period and address period, the reset period and address period allocated to each sub-field are short. A short reset period brings about unstable initialization of a cell. Furthermore, a short address period causes an unstable address discharge and thus cells that should be lit may not be addressed. Therefore, what is needed is a plasma display device and a method of driving a plasma display device that produces stable discharges.

### SUMMARY OF THE INVENTION

It is therefore an object of the present invention to provide an improved plasma display device that results in more stable discharges.

It is also an object of the present invention to provide an improved method of driving a plasma display panel that results in more stable discharges.

These and other objects can be achieved by a plasma display device and a method of driving a plasma display device that adjusts a period of a sustain discharge based on the display load ratio. In one aspect of the present invention, a plasma display device where one frame is divided into a plurality of sub-fields to be driven is provided. The plasma display device includes a plasma display panel including a plurality of discharge cells, the first and second electrodes passing the discharge cells, a driver for applying a first sustain discharge waveform having alternating first and second voltages to the first electrode and applying a second sustain discharge waveform having alternating third and fourth voltages to the second electrode to generate a sustain discharge at a selected discharge cell, and a controller for calculating a display load ratio in at least one sub-field from an input video signal and determining periods of the first and second sustain discharge waveforms based on the display load ratio. The controller adjusts the periods of the first and second sustain discharge waveforms based on the load ratio, and the periods are shorter when the load ratio is high and the periods are longer when the load ratio is low.

In one exemplary embodiment of the present invention, the controller determines the display load ratio from the level of a video signal corresponding to one frame. In another exemplary embodiment of the present invention, the controller calculates the number of lit discharge cells in each sub-field and determines the display load ratio based on the number of lit discharge cells. In still another exemplary embodiment of the present invention, the controller determines the display load ratio from the sum of the numbers of lit discharge cells in sub-fields corresponding to one frame. In a further exemplary embodiment of the present invention, the controller stores data of the periods of the first and second sustain discharge waveforms based on the display load ratio. In a yet further exemplary embodiment of the present invention, the third voltage is identical to the second voltage and the fourth voltage is identical to the first voltage.

In another aspect of the present invention, there is provided a method of driving a plasma display panel device having a plurality of discharge cells, the first and second electrodes passing the discharge cells, where one frame is divided into a plurality of sub-fields, and a first sustain discharge waveform having alternating first and second voltages is applied to the first electrode and a second sustain discharge waveform having alternating third and fourth voltages is applied to the second electrode to generate a sustain discharge at a selected discharge cell at each sub-field. The driving method includes calculating a display load ratio in at least one sub-field from an input video signal, and calculating periods of the first and second sustain discharge waveforms based on the display load ratio. Here, periods of the first and second sustain discharge waveforms at a first display load ratio are shorter than periods of the first and second sustain discharge waveforms at a second display load ratio when the second display load ratio is higher than the first display load ratio.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial perspective view of an AC plasma display panel;

FIG. 2 illustrates the arrangement of electrodes of a plasma display panel of FIG. 1;

FIG. 3 illustrates the configuration of a plasma display device according to an embodiment of the present invention;

FIG. 4 illustrates waveforms for driving a plasma display panel according to an embodiment of the present invention;

FIG. 5 is a block diagram of a controller of a plasma display panel according to an embodiment of the present invention; and

FIG. 6 illustrates variations in periods of sustain discharge waveforms in response of a display load ratio.

### DETAILED DESCRIPTION OF THE INVENTION

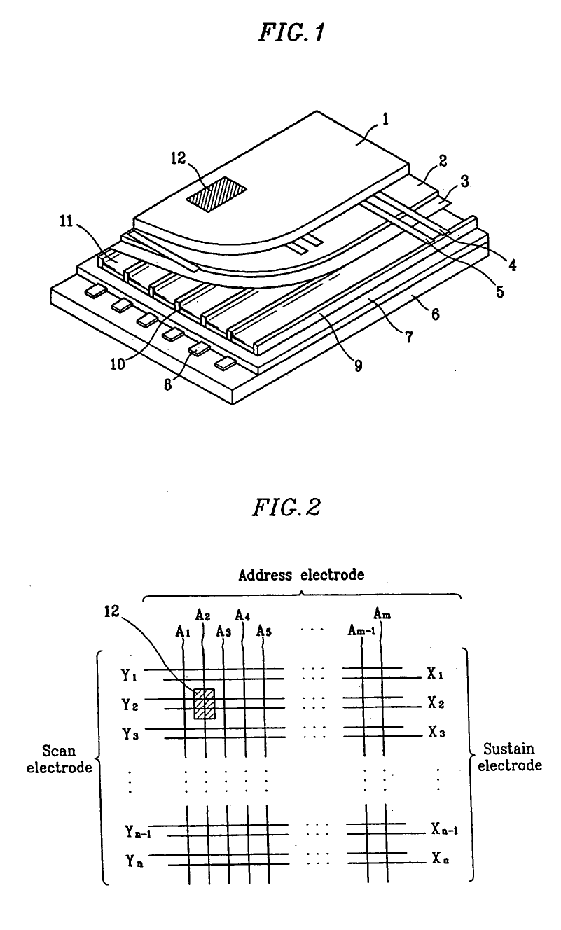

Turning now to the figures, FIG. 1 is a partial perspective view of an AC plasma display panel. Referring to FIG. 1, a scan electrode 4 and a sustain electrode 5 are arranged in pairs and in parallel on a substrate 1 and are covered with a dielectric layer 2 and a protective layer 3. A plurality of address electrodes 8 are arranged on another substrate 6 and are covered with an insulating layer 7. Ribs 9 are formed on portions of the insulating layer 7 that correspond to spaces between adjacent address electrodes 8 and in parallel with the address electrodes 8. In addition, a fluorescent material 10 is located on the surface of the insulating layer 7 and on both sides of the ribs 9. The two substrates 1 and 6 are arranged opposite to each other having a discharge space 11 between them such that the scan electrode 4 and sustain electrode 5 are perpendicular to the address electrodes. A discharge space located at the intersection of the pair of the scan and sustain electrodes 4 and 5 and each address electrode 8 forms a discharge cell 12.

In the structure of FIG. 1, when a discharge voltage is applied to two arbitrary electrodes, for example, a scan electrode 4 and an address electrode 8 or a scan electrode 4 and a sustain electrode 5, charges (electrons or positive ions) generated caused by discharge are attached to the surface of the dielectric layer 2 to cause a voltage drop and discharge and then the discharge is stopped. To generate a discharge, the polarity of voltage applied to the electrodes should be inverted. For convenience, the charges attached to the dielectric layer 2 are called “wall charges”. The accumulation of wall charges on the surface of the dielectric layer 2 is considered as an accumulation of wall charges near the scan electrode, sustain electrode, and address electrode.

FIG. 2 illustrates the arrangement of electrodes of the plasma display panel of FIG. 1. Referring to FIG. 2, the electrodes of the plasma display panel are arranged in an n×m matrix form. Specifically, address electrodes A₁ through Aₘ are arranged in a column direction and scan electrodes Y₁ through Yₙ and sustain electrodes X₁ through Xₙ are arranged in a row direction. A cell 12 illustrated in FIG. 2 corresponds to the cell 12 illustrated in FIG. 1. The ends of the sustain electrodes X₁ through Xₙ are connected such that the sustain electrodes X₁ through Xₙ are simultaneously driven with the same voltage waveform.

In the AC type plasma display panel of FIGS. 1 and 2, a single temporal frame is divided into a plurality of sub-fields. Each sub-field temporally includes a reset period, an address period and a sustain period. The reset period initializes the state of each cell such that the cell is smoothly addressed. The address period distinguishes lit cells (addressed cells) from cells that are not lit and accumulates wall charges in the lit cells. That is, the address period increases the quantity of charges attached to the lit cells. During the sustain period, a predetermined number of discharges are generated in the addressed cells in order to display an image.

Since each sub-field includes a reset period and an address period, the reset period and the address period allocated to each sub-field are short. A short reset period brings about unstable initialization of a cell. Furthermore, a short address period causes an unstable address discharge and thus cells that should be lit may not be addressed.

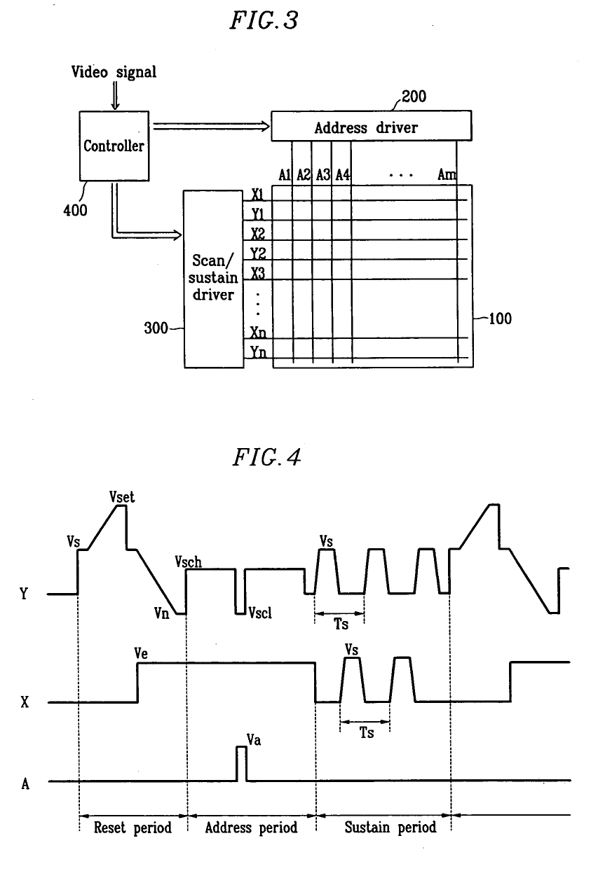

FIG. 3 illustrates the configuration of a plasma display device according to an embodiment of the present invention. Referring to FIG. 3, the plasma display device includes a plasma display panel 100, an address driver 200, a scan/sustain driver 300, and a controller 400. While the scan/sustain driver 300 is represented as a single block in FIG. 3, a scan driver and a sustain driver in general are separated from each other. The scan driver and sustain driver can, however, be integrated into one unit.

The plasma display panel 100 includes a plurality of address electrodes A₁ through Aₘ arranged in a column direction and a plurality of scan electrodes Y₁ through Yₙ and sustain electrodes X₁ through Xₙ arranged in pairs in a row direction.

The address driver 200 receives an address driving control signal from the controller 400 and applies an address signal for selecting a cell to be displayed to a corresponding address electrode to cause an address discharge. Specifically, the address driver 200 applies light-emission/non-light-emission pattern signals to the address electrodes A₁ through Aₘ when a corresponding scan electrode Yᵢ is at a scan voltage and other scan electrodes are at a non-scan voltage. Then, a discharge occurs between address electrodes where the light-emission pattern signal is applied and the corresponding scan electrode Yᵢ to form a column pattern of wall charges. The column pattern is formed for all of the scan electrodes Y₁ through Yₙ to address one sub-field.

The scan/sustain driver 300 receives a sustain discharge control signal from the controller 400 and alternately applies a sustain discharge waveform to the scan electrodes Y₁ through Yₙ and sustain electrodes X₁ through Xₙ to generate a sustain discharge for the selected cells. The scan/sustain driver 300 repeatedly generates the sustain discharge for each sub-field a predetermined number of times to display a sub-field image with a predetermined luminance. When the sustain discharge waveform is applied to the scan electrodes and sustain electrodes, the scan electrodes and sustain electrodes serve as capacitive loads. Thus, reactive power for generating a predetermined voltage in the capacitive loads is required in addition to power for generating a discharge in order to apply the sustain discharge waveform to the scan electrodes and sustain electrodes. Accordingly, the scan/sustain driver 300 includes a power recovery circuit for recovering the reactive power to recycle it. The power recovery circuit increases or decreases the voltage of the scan electrodes or sustain electrodes using resonance of a capacitive load and an inductor.

The controller 400 receives a video signal from an external device, generates the address driving control signal and the sustain discharge control signal, and respectively transmits the address driving control signal and the sustain discharge control signal to the address driver 200 and the scan/sustain driver 300. In addition, the controller 400 calculates a display load ratio in response to a signal level of the received video signal and controls the period of the sustain discharge waveform based on the display load ratio. Here, the period of the sustain discharge waveform corresponds to an interval between the moment when the sustain discharge waveform is applied to a single electrode and the moment when the next sustain discharge waveform is applied to the same electrode.

Waveforms applied to the scan electrodes, sustain electrodes and address electrodes during a reset period, an address period, and a sustain period of a single sub-field will now be explained with reference to FIG. 4. FIG. 4 illustrates waveforms required for driving the plasma display panel according to the embodiment of the present invention. Referring to FIG. 4, the scan electrodes Y are provided with a waveform gradually increasing from a voltage Vs to a voltage Vset while the address electrodes A and sustain electrodes X are provided with a ground voltage during the reset period. Then, a weak reset discharge is generated from the scan electrodes Y to the address electrodes A and sustain electrodes X and thus negative wall charges accumulate near the scan electrodes Y, and simultaneously, positive wall charges accumulate near the address electrodes A and sustain electrodes X.

Subsequently, the sustain electrodes X are maintained at a voltage Ve and a waveform gradually decreasing from the voltage Vs to the ground voltage is applied to the scan electrodes Y. Then, a weak reset discharge occurs again and thus the negative wall charges of the scan electrodes Y are erased and the positive wall charges of the sustain electrodes X and address electrodes A are also erased. While a resetting method that applies a waveform with increasing voltage to the scan electrodes Y and then applies decreasing voltage thereto is used in this embodiment, however, a resetting method different from the method illustrated in FIG. 4 can be also used.

During the address period, a scan voltage Vsel is applied to a scan electrode to select the scan electrode while other scan electrodes are maintained at a non-scan voltage Vsch. An address voltage Va is applied to a to-be-selected address electrode among address electrodes intersecting the scan 5 electrode has been selected. Then, a discharge occurs between the selected scan electrode and the selected address electrode according to a potential difference between the scan voltage Vsel and address voltage Va. The discharge between the scan electrode Y and address electrode A causes a discharge between the scan electrodes and sustain electrodes and thus positive wall charges accumulate on the scan electrodes Y and negative wall charges accumulate on the sustain electrodes X.

During the sustain period, a sustain discharge waveform having a predetermined period Ts is applied to the scan electrodes Y and the sustain electrodes X. Specifically, a sustain discharge waveform having a voltage Vs is applied to the scan electrodes Y while the sustain electrodes X are maintained at the ground voltage to result in a sustain discharge between the scan electrodes Y and sustain electrodes X. As a result of the sustain discharge, negative wall charges accumulate near the scan electrodes Y and positive wall charges accumulate near the sustain electrodes X. Subsequently, the sustain discharge waveform having the voltage Vs is applied to the sustain electrodes X while the scan electrodes Y are held at the ground voltage. This generates a sustain discharge between the scan electrodes Y and sustain electrodes X. As a result of this sustain discharge, positive wall charges accumulate near the scan electrodes Y and negative wall charges accumulate on the sustain electrodes X. The sustain discharge waveform is alternately applied to the scan electrodes Y and sustain electrodes X a predetermined number of times to produce a predetermined luminance.

After the sustain discharge, the sustain discharge voltage is maintained at the voltage Vs for a predetermined period of time such that an appropriate quantity of wall charges can accumulate near the scan electrodes Y and the sustain electrodes X in preparation for the next discharge. The length of time during which the sustain electrodes are held at the voltage Vs is determined based on the period Ts of the sustain discharge waveform. As described above, the voltage applied to the sustain electrode is increased or decreased at a predetermined gradient because resonance of the inductor and capacitive load is used when the voltage applied to the sustain electrode is increased or decreased.

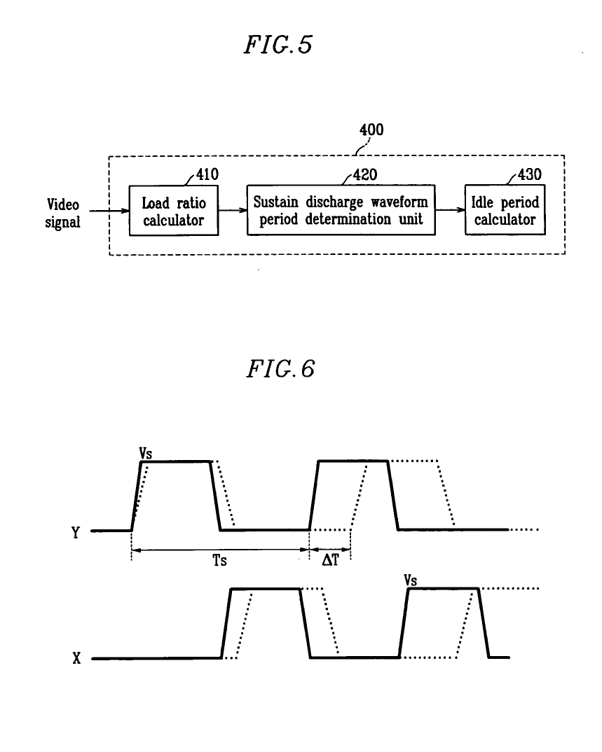

The controller of the plasma display panel according to the present invention and the period Ts of sustain discharge waveform in response to the display load ratio will now be explained in detail with reference to FIGS. 5 and 6. FIG. 5 is a block diagram of the controller 400 of the plasma display panel 100 according to the present invention, and FIG. 6 illustrates variations in the periods Ts of sustain discharge waveforms in response to a display load ratio.

Referring to FIG. 5, the controller 400 includes a load ratio calculator 410, a sustain discharge waveform period determination unit 420, and an idle period calculator 430. The load ratio calculator 410 calculates a display load ratio L/R for each frame from an input video signal. In general, the display load ratio is given by an average of input video signal levels, as represented by Equation 1.

$$L / R = \frac{{\sum }_{j = 1}^{M} {\sum }_{i = 1}^{N} {R}_{ij} + {\sum }_{j = 1}^{M} {\sum }_{i = 1}^{N} {G}_{ij} + {\sum }_{j = 1}^{M} {\sum }_{i = 1}^{N} {B}_{ij}}{N \times M \times 3} \qquad [ Equation 1 ]$$

Here, Rᵢⱼ, Gᵢⱼ, and Bᵢⱼ respectively represent levels of input R, G, and B video signals, and i and j respectively denote a row and a column. In addition, M and N respectively represent the numbers of columns and rows.

The sustain discharge waveform period determination unit 420 determines the width Ws of a sustain discharge waveform based on the display load ratio L/R. In general, the gradient of the sustain discharge waveform is decreased and the sustain discharge waveform becomes unstable as the display load ratio is increased. Accordingly, it is required to sufficiently secure the interval of the voltage Vs in the sustain discharge waveform in order to stably generate wall charges after a sustain discharge. Therefore, the period of the sustain discharge waveform is determined from an interval during which a stable optical waveform can be obtained when the display load ratio is higher.

As the display load ratio L/R is decreased, the gradient of the sustain discharge waveform is increased to make the sustain discharge waveform more stable. Thus, wall charges are rapidly stabilized when the display load ratio is lower. Accordingly, the period Ts of the sustain discharge waveform can be reduced when the display load ratio is lower. Table 1 represents the results of measurement of stability of an optical waveform in response to the period Ts of the sustain discharge waveform and the display load ratio L/R. In Table 1, ‘1’, ‘5’, and ‘9’ represent a good waveform state, an average waveform state, and a poor waveform state, respectively.

TABLE 1

| | |
|---|---|
| Load ratio | Period (μs) |

| (%) | 4.5 | 4 | 3.5 | 3 |
|---|---|---|---|---|
| 100 | 5 | 5 | 9 | 9 |
| 95 | 5 | 5 | 9 | 9 |
| 90 | 5 | 5 | 9 | 9 |
| 85 | 1 | 5 | 9 | 9 |
| 80 | 1 | 5 | 9 | 9 |
| 75 | 1 | 5 | 9 | 9 |
| 70 | 1 | 1 | 9 | 9 |
| 65 | 1 | 1 | 9 | 9 |
| 60 | 1 | 1 | 9 | 9 |
| 55 | 1 | 1 | 9 | 9 |
| 50 | 1 | 1 | 9 | 9 |
| 45 | 1 | 1 | 9 | 9 |
| 40 | 1 | 1 | 9 | 9 |
| 35 | 1 | 1 | 9 | 9 |
| 30 | 1 | 1 | 9 | 9 |
| 25 | 1 | 1 | 9 | 9 |
| 20 | 1 | 1 | 5 | 9 |
| 15 | 1 | 1 | 5 | 9 |
| 10 | 1 | 1 | 1 | 9 |
| 5 | 1 | 1 | 1 | 5 |
| 1 | 1 | 1 | 1 | 1 |

As can be seen from Table 1, when the display load ratio L/R is high, the period of the sustain discharge waveform Ts needs to be increased in order to have a stable waveform. Also, when the display load ratio L/R is low, it is possible to have a stable waveform, even when the period of the sustain discharge Ts is reduced.

Accordingly, the sustain discharge waveform period determination unit 420 reduces the period Ts of the sustain discharge waveform by a predetermined period of time AT when the display load ratio L/R is low, as illustrated in FIG. 6. The period Ts is determined such that the optical waveform is stably output based on the display load ratio through experiments in advance. A relationship between the determined display load ratio L/R and the period Ts can be stored in the form of a look-up table in a memory. According to the experimental data as represented in Table 1, the period Ts can be set to 4.5 μs, 4.0 μs, 3.5 μs, and 3.0 μs when the display load ratio L/R is 75 to 100%, 15 to 74%, 5 to 14%, and 1 to 14%, respectively.

The idle period calculator 430 determines an idle period in a single frame based on the display load ratio L/R and the period Ts of the sustain discharge waveform determined by the sustain discharge waveform period determination unit 420. In general, the number of lit discharge cells is increased when the display load ratio L/R is high to result in an increase in power consumption. Accordingly, an automatic power control algorithm is applied to the plasma display panel to determine the number of sustain discharge waveforms allocated to a single frame based on the display load ratio L/R. Generally, a single frame is made up of a plurality of sub-fields and each of the sub-fields has an appropriate weight for representing its gradation. When the number of all the sustain discharge waveforms is determined, the number of sustain discharge waveforms allocated to each sub-field is determined based on the weight of each sub-field. Since the number of lit discharge cells is increased when the display load ratio is higher and thus when power consumption is increased, the number of the entire sustain discharge waveforms is reduced to decrease power consumption.

Accordingly, the idle period calculator 430 calculates the length of the sustain period in consideration of the number of sustain discharge waveforms and the periods of sustain discharge waveforms determined based on the display load ratio. In addition, the idle period calculator 430 determines the idle period in consideration of the reset period, address period, and the length of the sustain period of a single frame and a margin between adjacent periods. Though the number of sustain discharge waveforms is increased to reduce the idle period when the display load ratio is low, the period of the sustain discharge waveform is reduced according to the embodiment of the present invention and thus the length of the idle period can be increased.

The controller 400 allocates the determined idle period to the address period to increase the width of an address waveform in the address period such that an address discharge can stably occur. Furthermore, the controller 400 allocates the idle period to the reset period such that an appropriate quantity of wall charges can be set during the reset period. Moreover, the controller 400 can further allocate a single sub-field to the idle period. Here, power of expressing low gray scales can be improved when a sub-field with a low weight is allocated and pseudo-contour effect can be reduced when a sub-field with a high weight is divided into two sub-fields.

While the display load ratio is calculated from the input video signal in the embodiment of the present invention, the display load ratio can be measured from the number of lit cells in the plasma display panel.

When it is assumed that a single frame is divided into 8 sub-fields 1SF through 8SF respectively having idle period weights 1, 2, 4, 8, 16, 32, 64, and 128 to be driven in order to express 256 gray scales in the plasma display panel, a video signal with gray scale 100 is converted into 8-bit data “00100110”. The numbers “00100110” sequentially correspond to the 8 sub-fields. Here, ‘0’ represents that a discharge cell (dot) is not discharged (OFF) in a corresponding sub-field and ‘1’ represents that a discharge cell is discharged (ON) in a corresponding sub-field. That is, the controller 400 converts a video signal corresponding to each cell into data representing ON or OFF in each sub-field. The display load ratio L/R can be determined by measuring the number of ON cells from the ON/OFF data for each sub-field.

The load ratio calculator 410 calculates the display load ratio L/R for each frame, and the sustain discharge waveform period determination unit 420 can determine the periods of sustain discharge waveforms in all sub-fields corresponding to a single frame. Otherwise, the load ratio calculator 410 calculates the display load ratio L/R for each sub-field from the ON/OFF data, and the sustain discharge waveform period determination unit 420 respectively determines the periods of sustain discharge waveforms in respective sub-fields.

According to the present invention, the period of a sustain discharge waveform can be varied with a display load ratio to increase the length of an idle period. The idle period can be allocated to an address period or reset period to stabilize discharges. Furthermore, a single sub-field can be further allocated to the idle period to improve power of expressing low gray scales or reduce pseudo-contour.

In the preceding detailed description, only the preferred embodiment of the invention has been illustrated and described, simply by way of illustration of the best mode contemplated by the inventor(s) of carrying out the invention. It is to be appreciated that the invention is capable of modification in various obvious respects, all without departing from the invention. Accordingly, the drawings and description are to be regarded as illustrative in nature, and not restrictive. To clarify the present invention, parts that are not described in the specification are omitted, and parts for which similar descriptions are provided have the same reference numerals.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A plasma display device, comprising:
a plasma display panel comprising a plurality of discharge cells, the first and second electrodes passing the discharge cells;
a driver adapted to apply a first sustain discharge waveform comprising alternating first and second voltages to the first electrode and the driver being adapted to apply a second sustain discharge waveform having alternating third and fourth voltages to the second electrode to generate a sustain discharge at a selected discharge cell; and
a controller programmed and configured to calculate a display load ratio in at least one sub-field from an input video signal, the controller being programmed and configured to determine periods of the first and second sustain discharge waveforms based on the display load ratio, the controller being programmed and configured to make periods of the first and second sustain discharge waveforms at a first display load ratio be shorter than periods of the first and second sustain discharge waveforms at a second display load ratio when the second display load ratio is higher than the first display load ratio.

2. The plasma display device of claim 1, the controller being programmed and configured to determine the display load ratio from a level of a video signal corresponding to one frame.

3. The plasma display device of claim 1, the controller being programmed and configured to calculate a number of lit discharge cells in each sub-field and being programmed and configured to determine the display load ratio based on the number of lit discharge cells.

4. The plasma display device of claim 3, the controller being programmed and configured to determine the display load ratio from a sum of the numbers of lit discharge cells in sub-fields corresponding to one frame.

5. The plasma display device of claim 1, the controller being programmed and configured to store data of the periods of the first and second sustain discharge waveforms based on the display load ratio.

6. The plasma display device of claim 1, the controller being programmed and configured to calculate an idle period in one frame based on the determined periods of the first and second sustain discharge waveforms.

7. The plasma display device of claim 1, the third voltage being identical to the second voltage and the fourth voltage being identical to the first voltage.

8. A method of driving a plasma display panel in a plasma display device, comprising:
providing the plasma display panel that comprises a plurality of discharge cells with first and second electrodes passing the discharge cells, where one frame is divided into a plurality of sub-fields, and a first sustain discharge waveform having alternating first and second voltages is applied to the first electrode and a second sustain discharge waveform having alternating third and fourth voltages is applied to the second electrode generating a sustain discharge at a selected discharge cell at each sub-field;
calculating a display load ratio in at least one sub-field from an input video signal; and
calculating periods of the first and second sustain discharge waveforms based on the display load ratio, wherein periods of the first and second sustain discharge waveforms at a first display load ratio are shorter than periods of the first and second sustain discharge waveforms at a second display load ratio that is higher than the first display load ratio.

9. The method of claim 8, the calculating the display load ratio comprises calculating the display load ratio from the sum of levels of video signals corresponding to one frame.

10. The method of claim 8, the calculating the display load ratio comprises calculating the display load ratio from the sum of the numbers of lit discharge cells in sub-fields corresponding to one frame.

11. The method of claim 8, further comprising calculating an idle period in one frame based on the periods of the first and second sustain discharge waveforms.

12. A plasma display device, comprising:
a plasma display panel comprising a plurality of discharge cells, the first and second electrodes passing the discharge cells;
a driver adapted to apply a first sustain discharge waveform comprising alternating first and second voltages to the first electrode and the driver being adapted to apply a second sustain discharge waveform having alternating third and fourth voltages to the second electrode to generate a sustain discharge at a selected discharge cell; and
a controller programmed and configured to receive video signals from an external source and generate appropriate driver control signals for the driver based on the received video signals, the controller comprising:
a load ratio calculator adapted to calculate a load ratio of each frame; and
a sustain discharge waveform period determination unit adapted to determine a period of the first sustain discharge waveform and a period of the second sustain discharge waveform.

13. The plasma display device of claim 12, the sustain discharge waveform determination unit being adapted to determine the periods of the first and the second sustain discharge waveforms based on the load ratio calculated by the load ratio calculator.

14. The plasma display device of claim 13, the plasma display device further comprises a look up table in a memory that is accessed by the sustain discharge waveform period determination unit in order to determine the periods of the first and the second sustain discharge waveforms, the look up table comprising a correspondence between a load ratio and a period for the first and the second sustain discharge waveforms.

15. The plasma display panel of claim 13, the determined periods of the first and the second sustain discharge waveforms being larger for lower load ratios and being smaller for larger load ratios.

16. The plasma display panel of claim 13, the controller further comprising an idle period calculator adapted to calculate an idle period for a frame based on the determined periods for the first and the second sustain discharge waveforms.

17. The plasma display panel of claim 12, the load ratio calculator being adapted to calculate the load ratio from a number of lit discharge cells in sub-fields corresponding to the frame.

18. The plasma display panel of claim 12, the load ratio calculator being adapted to calculate the load ratio from measuring a number of ON cells from ON/OFF data for each sub-field in the frame.
